(19) United States
(12) Patent Application Publication
(10) Pub. No.: US 2010/0187251 A1
(43) Pub. Date: Jul. 29, 2010

(54) Infection Control Station

(76) Inventor: Robert Simmons, Hudson, WI (US)

Correspondence Address: Larry E Severin, Esq, 3581 Teaberry Circle, Seal Beach, CA, 90740, US

(21) Appl. No.: 12/693,197

(22) Filed: Jan. 25, 2010

Related U.S. Application Data
(60) Provisional application No. 61/147,240, filed on Jan. 26, 2009.

(51) Int. Cl. A47F 1/00; B67D 7/06

(52) U.S. Cl. 221/96; 222/181.3; 222/192

(57) ABSTRACT

A infection control station includes: a mounting unit; a cover rotatably attached to the mounting unit, adapted to transition between an open position and a closed position; a pump adapted to dispense the hand sanitizer; a site window to view the hand sanitizer when the cover is in the closed position; an aperture adapted to dispense the towel; and a site window to view the towel when the cover is in the closed position. The station may also include a hinge that pivotally attaches a first side of the cover to the mounting unit; a lock that releasably secures a second side of the cover against the mounting unit; and a shelf that is accessible when the cover is in the open position and is not accessible when the cover is in the closed position.

### RELATED APPLICATIONS

This application claims the benefit of the filing date of U.S. patent application Ser. No. 61/147,240, filed Jan. 26, 2009, which is incorporated herein by reference in its entirety.

### BACKGROUND OF THE INVENTION

The present invention generally relates to infection control and more specifically to an infection control station.

Existing systems do not combine both hand sanitizers and anti-microbial wipes in a single housing. These systems also do not have shelves or dispensers for first aid kits or gloves.

It would be desirable to provide a station that includes both a towel dispenser and a hand sanitizer dispenser in a single unit.

### SUMMARY OF THE INVENTION

In one aspect of the present invention, a device includes: a housing adapted to be mounted on a wall; a hand sanitizer dispenser retained by the housing; and a towel dispenser retained by the housing.

In another aspect of the present invention, an infection control station that provides a hand sanitizer and a towel includes: a mounting unit; a cover rotatably attached to the mounting unit, adapted to transition between an open position and a closed position; a pump adapted to dispense the hand sanitizer; a site window to view the hand sanitizer when the cover is in the closed position; an aperture adapted to dispense the towel; and a site window to view the towel when the cover is in the closed position.

In yet another aspect of the present invention, a method of providing a hand sanitizer and a towel includes: mounting a housing on a wall; retaining the hand sanitizer dispenser within the housing; dispensing the hand sanitizer dispenser; retaining the towel within the housing; and dispensing the towel.

### BRIEF DESCRIPTION OF THE DRAWINGS

FIG. 1 is a front view of an embodiment of the present invention with the cover closed;

FIG. 2 is a side view of the embodiment of FIG. 1;

FIG. 3 is a back view of the embodiment of FIG. 1;

FIG. 4 is a bottom view of the embodiment of FIG. 1;

FIG. 5 is a top view of the embodiment of FIG. 1;

FIG. 6 is a view of the inside an embodiment of FIG. 1, empty; and

FIG. 7 is a view of the inside of the embodiment of FIG. 1 in use.

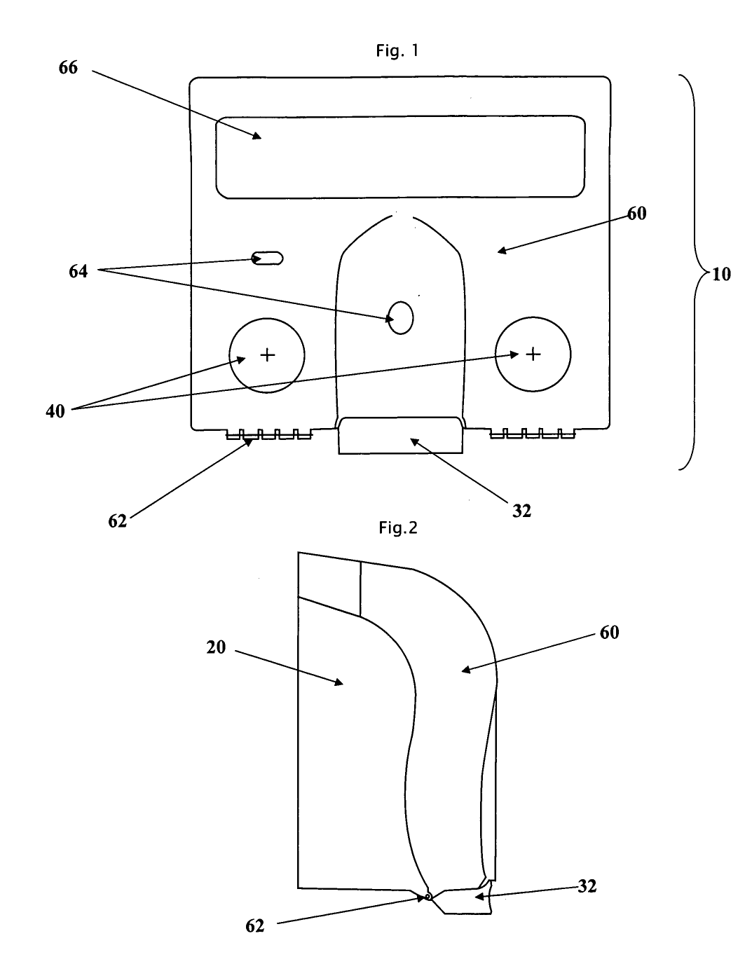

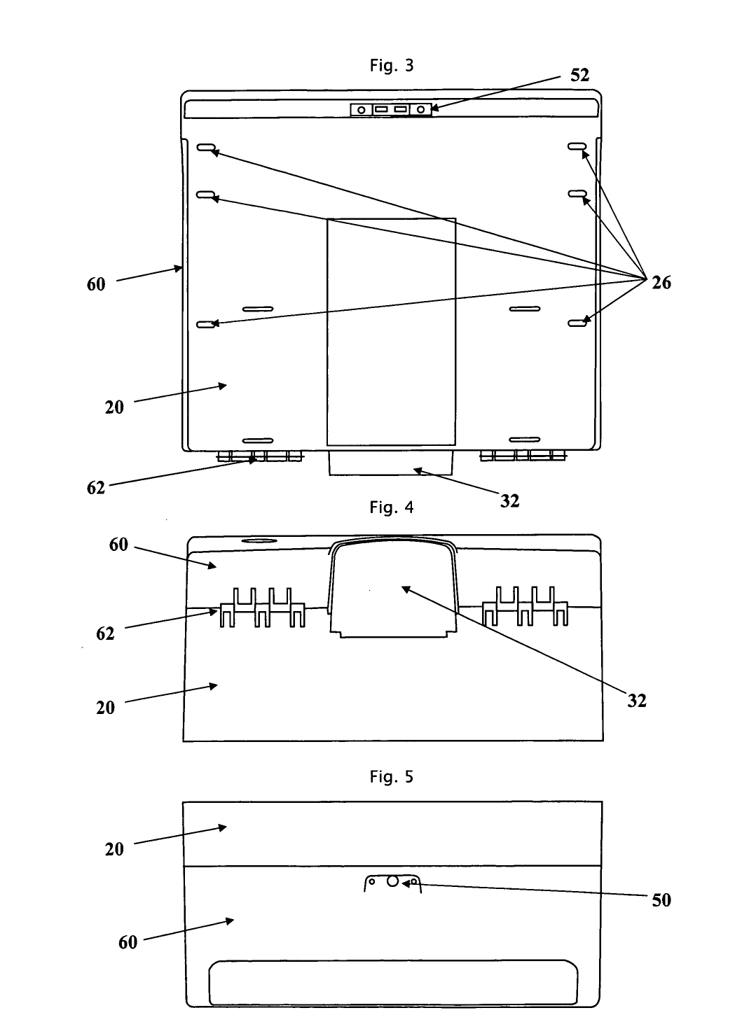

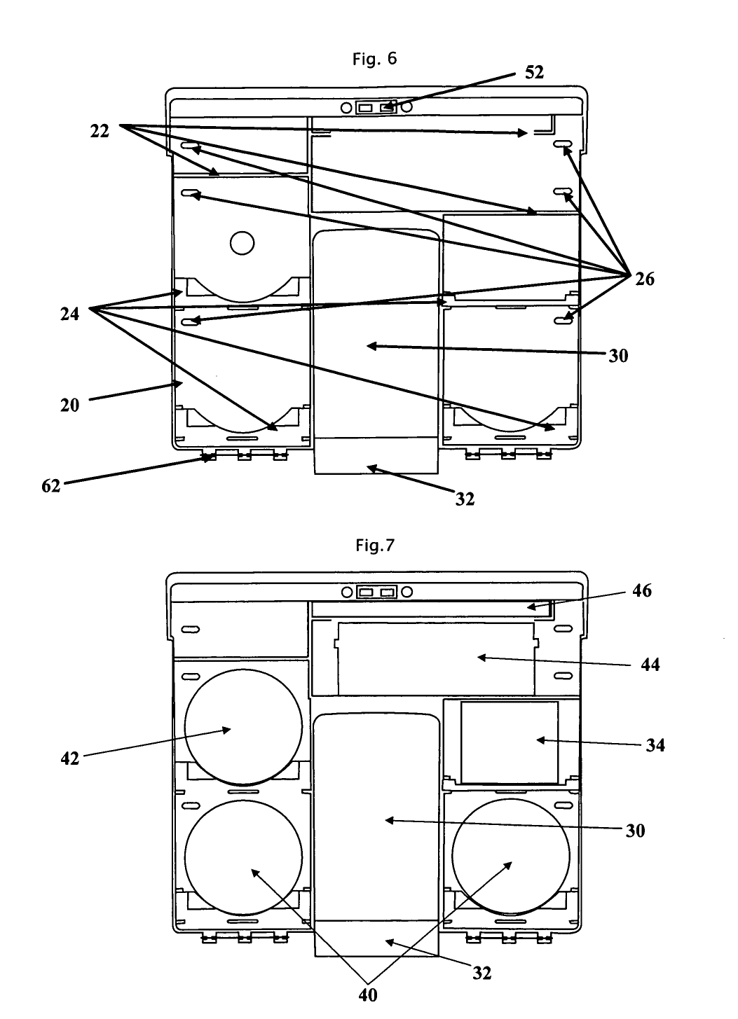

### DETAILED DESCRIPTION

The preferred embodiment and other embodiments, including the best mode of carrying out the invention, are hereby described in detail with reference to the drawings. Further embodiments, features and advantages will become apparent from the ensuing description or may be learned without undue experimentation. The figures are not drawn to scale, except where otherwise indicated. The following description of embodiments, even if phrased in terms of “the invention,” is not to be taken in a limiting sense, but describes the manner and process of making and using the invention. The coverage of this patent will be described in the claims. The order in which steps are listed in the claims does not indicate that the steps must be performed in that order.

An embodiment of the present invention generally provides an infection control station. Embodiments may be called “Classroom Caddy” or “Classroom Caddy—Infection Control Station.” Embodiments may include an infection control station that mounts on a wall of a classroom, fitness area, gym, healthcare facilities, etc. that contains anti-microbial products which can be used to disinfect working areas and proper hygiene for individuals of the learning or fitness environments while meeting state guidelines where necessary.

An embodiment of the present invention may include a wall-mounted cabinet with a cover attached to a base mounting unit for movement longitudinally. The cover may carry a lock that aligns with the locking plate attached to the base mounting unit. The cover may have two sight windows, one enabling the viewing of the hand sanitizer and the other enabling the viewing of the refill canister of wipes when the cover is closed. The cover may also have two circular openings which align directly with the placement of two open canisters of wipes, or one open canister of wipes and one open package of tissues enabling retraction of wipes and/or tissue without opening the cover. An embodiment may also have an open space in the bottom between the cover and the base mounting unit enabling access of the hand sanitizer dispenser without opening the cover.

Embodiments may include a base mounting unit, an inner shelving or shelf, a cover, a lock, a lock plate, and hinge pins. The cover, with a built-in hinge pin retainer located at the bottom of the cover, may be aligned with the other built-in hinge pin retainer located on the bottom of the base mounting unit and connected by way of a steel pin. The shelving may be placed in slot locked positions within the embodiment. The lock may be fastened in to the top of the cover, which aligns and locks in to the lock plate, which is fastened in to the top portion of the base mounting unit.

Embodiments may have one or more of the following: a hand sanitizer dispenser mounted inside the embodiment; a towel dispenser attached or mounted on either side of the embodiment; and a glove dispenser attached to or mounted around the embodiment. A towel may be a wet wipe, an anti-microbial wipe, a tissue, a paper towel, or any other cloth or paper for cleaning, wiping or drying.

As depicted in the figures, an embodiment 10 of the invention may include a base mounting unit or housing 20 that mounts to the wall through the mounting holes 26. The base mounting unit 20 may include built-in shelving 22 and snap-in shelving 24. The embodiment 10 may have a space for the instant hand sanitizer dispenser 30 which is accessed via the pump 32, a refill unit of hand sanitizer 34, two spaces for open canisters of disinfecting wipes 40 and one space for a wipe canister backup 42. An individual wipe will be pulled out manually through the cover 60 of the embodiment 10. The cover 60 carries a lock 50 that aligns with the lock plate 52 that is secured to the base mounting unit 20. The embodiment 10 also may have space for a first aid kit 44 and a six pack of examination gloves 46. The cover 60 may be connected to the base mounting unit 20 by built-in hinges and steel hinge pins 62 located at the bottom of the embodiment 10. The cover 60 may have two sight windows 64 aligned with the wipe canister backup 42 and the hand sanitizer dispenser 30 for easy inventory check. The cover 60 also may have an area to be used for a nameplate/sticker 64 which will designate use for such areas as, but not limited to, the classroom, fitness area, health facility, jails, etc.

In an embodiment, the base mounting unit 20 may be made of materials such as but not limited to plastic, polyvinyl chloride (PVC), steel, aluminum (or any other metal or metal alloy). The shelving 22, 24 inserts may be made of materials such as but not limited to plastic, PVC, steel, aluminum, or any other metal or metal alloy. The cover 60 may be made of materials such as but not limited to plastic, PVC, steel, aluminum, or any other metal or metal alloy. The lock 50 may be made of materials such as but not limited to plastic, PVC, steel, aluminum (or any other metal or metal alloy). The lock plate 52 may be made of materials such as but not limited to plastic, PVC, steel, aluminum, or any other metal or metal alloy. The hinge pins 62 may be made of materials such as but not limited to plastic, PVC, steel, aluminum, or any other metal or metal alloy. The lock 50 may be attached to the cover 60 by means such as but not limited to screws, nuts and bolts, grommets, heat, various adhesives or friction. The lock plate 52 may be attached to the base mounting unit 20 by means such as but not limited to screws, nuts and bolts, grommets, heat, various adhesives or friction. The inner shelves 22, 24 may be attached to the base mounting unit 20 by means such as but not limited to screws, nuts and bolts, grommets, heat, adhesives or friction. The base mounting unit 20 may have built-in shelves 22, 24 sized to store a six pack of examination gloves, a first aid kit, three canisters of wipes and a refill of hand sanitizer 40. Embodiments may be utilized as a hand sanitizer dispenser to be mounted inside the embodiment 10 with access from the outside without opening the cover 60. Embodiments of the cover 60 may open a full 180 degrees due to hinge design and location.

An embodiment of the invention includes a hand sanitizer 30, disinfectant wipes 40, and first aid kits 44. The top area of the container has a lock 50 only accessible for the teachers. The bottom section is for general use by all students and faculty.

An embodiment, which may be called a “Classroom Caddy Infection Control System (Caddy),” may include: a base mounting unit; inner shelving; a cover; a lock; a lock plate; and hinge pins. The bottom of the base mounting unit is attached to the bottom of the cover by way of hinges, the lock is secured to the cover, the lock plate is attached to the base mounting unit, and the inner shelving is attached to the base mounting unit. In an embodiment, the cover hinge halves and the base mounting unit hinge halves are pivotally attached using hinge pins thereto for movement between open and closed positions with respect thereto. In an embodiment, the lock is secured into the cover and movable between a position of engagement with the lock plate secured to the base mounting unit and a position out of engagement with the lock plate. In an embodiment, the inner shelving is secured to the base mounting unit by way of snapping into place with friction. In an embodiment, the cover hinge halves and base mounting unit hinge halves are part of the mold of the cover and base mounting unit. In an embodiment, the hinge pin is made of steel and secured by friction. In an embodiment, the lock is metal with key that when turned separates the two metal lock fingers allowing them to pass by the metal lock plate. In an embodiment, the lock is secured to the cover by screws, nuts and bolts, grommets, heat, various adhesives or friction. In an embodiment, the lock plate is secured to the base mounting unit by screws, nuts and bolts, grommets, heat, various adhesives or friction.

Embodiments may be used in healthcare facilities, jails treatment centers, and other training room facilities. An embodiment may mount on the wall of classrooms. A PVC container that contains anti-microbial products students and faculty can use to disinfect the working areas of the learning environment.

I claim:

1. A device, comprising:
a housing adapted to be mounted on a wall;
a hand sanitizer dispenser retained by the housing; and
a towel dispenser retained by the housing.

2. The device of claim 1, further comprising:
a first site window to view inside the hand sanitizer; and
a second site window to view inside the towel dispenser.

3. The device of claim 1, further comprising:
a shelf retained within the housing.

4. The device of claim 1, wherein the towel dispenser is adapted to retain and dispense a plurality of disinfecting wipes.

5. The device of claim 1, further comprising:
a cover having a first side and a second side generally opposite the first side;
a hinge that pivotally attaches the first side of the cover to the housing; and
a lock that releasably retains the second side of the cover against the housing.

6. The invention of claim 5, further comprising:
a lock plate fixed to the housing;
wherein the lock is fixed to the cover and the lock is adapted to transition between a position of engagement with the lock plate, where the device is secured closed, and a position out of engagement with the lock plate, where the device may be opened.

7. The invention of claim 6, wherein the lock includes a metal finger adapted to engage with the lock plate, further comprising:
a key that, when turned in the lock, separates the metal finger from the lock plate, thereby allowing the cover to move into the position out of engagement with the lock plate.

8. The invention of claim 5, further comprising
a first hinge pin retainer on the housing;
a second hinge pin retainer on the cover; and
a pin that pivotally retains the first hinge pin retainer to the second hinge pin retainer, thereby providing the hinge.

9. The device of claim 5, further comprising:
a shelf adapted to snap into the housing so that the housing retains the shelf by friction and the shelf is enclosed by the cover.

10. An infection control station that provides a hand sanitizer and a towel, comprising:
a mounting unit;
a cover rotatably attached to the mounting unit, adapted to transition between an open position and a closed position;
a pump adapted to dispense the hand sanitizer;
a site window to view the hand sanitizer when the cover is in the closed position;
an aperture adapted to dispense the towel; and
a site window to view the towel when the cover is in the closed position.

11. The station of claim 10, further comprising:
a hinge that pivotally attaches a first side of the cover to the mounting unit; and
a lock that releasably secures a second side of the cover against the mounting unit.

12. The station of claim 10, further comprising:
a shelf that is accessible when the cover is in the open position and is not accessible when the cover is in the closed position.

13. The station of claim 10, wherein the towel is a disinfecting wipe.

14. The station of claim 10, wherein the towel is a tissue.

15. A method of providing a hand sanitizer and a towel, comprising:
mounting a housing on a wall;
retaining the hand sanitizer dispenser within the housing;
dispensing the hand sanitizer dispenser;
retaining the towel within the housing; and
dispensing the towel.

16. The method of claim 15, further comprising:
utilizing a first site window to view into the housing to see the hand sanitizer; and
utilizing a second site window to view into the housing to see the towel.

17. The method of claim 15, further comprising:
providing a shelf within the housing; and
storing a first aid kit on the shelf.

18. The method of claim 15, further comprising:
rotatably attaching a cover to the housing; and
utilizing a lock to releasably secure the cover closed against the housing.

19. The method of claim 18, further comprising:
utilizing a key to unlock the cover; and
opening the cover, thereby providing access to a contents of the housing.

20. The method of claim 18, further comprising:
snapping a shelf into the housing so that the housing retains the shelf by friction;
storing an item on the shelf; and
closing the cover, thereby enclosing item.
